(19) United States
(12) Patent Application Publication
(10) Pub. No.: US 2014/0268691 A1
(43) Pub. Date: Sep. 18, 2014

(54) ILLUMINATED SHELVING SYSTEM

(71) Applicant: Jackie Ellis Hinkle, Mesa, AZ (US)

(72) Inventor: Jackie Ellis Hinkle, Mesa, AZ (US)

(21) Appl. No.: 13/841,415

(22) Filed: Mar. 15, 2013

(51) Int. Cl. A47F 5/00; F21V 33/00

(52) U.S. Cl. CPC A47F 5/00; F21V 33/0012
USPC 362/133; 29/428

(57) ABSTRACT

An illuminated shelving system is disclosed comprising components that are simple in design, aesthetically pleasing, and relatively inexpensive to manufacture and install, wherein the electrical connections for powering the illuminated shelves are hidden from view and do not detract from the aesthetic appeal of the shelving system.

### BACKGROUND OF THE INVENTION

1. Field of the Invention

The present invention relates generally to apparatus and methods for displaying of items in a commercial or retail environment. More particularly the present invention relates to a display shelving system including lighting fixtures mounted underneath.

2. Description of Related Art

In-store display lighting does affect shopper traffic and behavior and indeed drives up sales. Display lighting causes people to slow down, make eye contact, enter the store, browse longer at the display, pick up a product and handle it, then buy it. Therefore, to attract customers it is important that a merchandise display be aesthetically pleasing so as to present the merchandise to a potential customer in a highly visible and attractive manner. As such, display lighting isn't really an added cost, but rather an investment and it adds revenue.

Therefore, there is a need for illuminated shelving components that are simple in design, aesthetically pleasing, and relatively inexpensive to manufacture and install, wherein the electrical connections for powering the illuminated shelves are hidden from view and do not detract from the aesthetic appeal of the shelving system.

### SUMMARY OF THE INVENTION

The subject matter of this application may involve, in some cases, interrelated products, alternative solutions to a particular problem, and/or a plurality of different uses of a single system or article.

In one aspect, an illuminated shelving system is provided. In one embodiment, the illuminated shelving may comprise a first column, a second column, a shelf and a lighting system. The first column defining a plurality of apertures on a first side and the second column defining a plurality of apertures on a second side. The first side facing the second side. Each one of the plurality of apertures on the first and second columns, configured to removably receive supports for holding the shelf in position. The shelf having the light system detachably attached to an underside of a base of the shelf, wherein the lighting system is in electronic communication with an electrical power source through a wiring. The wiring being positioned in a hollow interior portion defined by the first column. The first and second column being securely attached to a wall.

In another embodiment, the illuminated shelving system further comprises an upper panel, wherein the upper panel is positioned above the shelf. The upper panel comprises a frame, a cover panel, and a second lighting system. The cover panel is attached to the frame and the frame is secured to the wall. The frame extends between the first and second column and is disposed to be flush with a top of the first column and a top of the second column. The second lighting system is detachably attached on a bottom portion of the frame to illuminate a space above the shelf.

In yet another embodiment, the illuminated system still further comprises a bottom shelf, wherein the bottom shelf may be positioned below the shelf.

In another aspect, a method for installing an illuminated shelving system is provided. The method may begin by securing a first column and a second column to a wall. The first column defining a plurality of apertures on a first side and the second column defining a plurality of apertures on a second side. This may be followed by removably engaging a support to one of the first and second pluralities of apertures. A shelf may then be positioned on at least two supports. A lighting system may be detachably attached on an underside of the shelf. The lighting system may then be electronically connected to an electrical power source by connecting through a wiring protruding from an opening in the first column. The wiring may be positioned in a hollow interior portion defined by the first column. In another embodiment, the method may further involve installing an upper panel above the shelf, wherein the upper panel comprises a frame, a cover panel, and a second lighting system. In yet another embodiment, the method may still further involve positioning a bottom shelf below the shelf.

### BRIEF DESCRIPTION OF THE DRAWINGS

FIG. 1 illustrates a front view of one embodiment of the illuminated shelving system when installed.

FIG. 2 illustrates views and details of a column.

FIG. 3 illustrates how the shelves are connected to a column.

FIG. 4 illustrates the various apertures, openings and holes on a side of a column.

FIG. 5 illustrates the views of a shelf.

FIG. 6 illustrates a light emitting diode (LED) strip connected to a power inlet connector.

FIG. 6B illustrates a lighting system attached to an underside of a shelf.

FIG. 7 illustrates an electrical power source connected to a power outlet connector.

FIG. 8 illustrates wiring components inside a hollow interior portion of a column.

FIG. 9 illustrates a rear view of an upper panel when installed.

FIG. 10 illustrates views of a bottom shelf.

FIG. 11 illustrates another embodiment of a column with a mirror attached.

FIG. 12 illustrates another embodiment of an illuminated shelving system.

FIG. 13 illustrates a side of a column showing the different components installed on it.

FIG. 14 illustrates an alternative embodiment of a shelf and the apertures in a column that work with the shelf.

FIG. 15 illustrates a wiring inside a column.

TABLE 1 provides the preferred dimensions of the various components of the illuminated shelving system

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. The drawings are not necessarily to scale, with emphasis instead generally being placed upon illustrating the principles of the presently disclosed embodiments.

Generally, the present invention relates to apparatus and methods for displaying of items in a commercial or retail environment.

FIG. 1 illustrates a front view of one embodiment of the illuminated shelving system when installed. In this embodiment, the illuminated shelving system 10 comprises a first column 11/40/121/140 and a second column 12/20/122 attached to a wall (not shown). A column may be attached to the wall by engaging the column over a stud, the stud being attached to the wall. A plurality of screws may then be used to secure the column to the stud through mounting holes 25/45/143. In another embodiment, a column may be attached to the wall by using various materials including, but not limited to, bolted steel angle, pop riveting, and the like.

In one embodiment, the first column 11/40/121/140 may define a substantially hollow first interior portion 41 and may also form a first plurality of apertures 42 on a first side 44 as shown in FIG. 4. Similarly, the second column 12/20/122 may define a substantially hollow second interior portion 21 and may also form a second plurality of apertures 22 on a second side 24 as shown in FIG. 2. The first side 44 of the first column 11/40/121/140 may be disposed to face the second side 24 of the second column 12/20/122. Each one of the first plurality and the second plurality of apertures 42/22 may be configured to removably receive a support, the support being for holding in position a shelf 14/32/124/150. In one embodiment, the support may be a connector 133 extending outwardly horizontally. The connector may be selected from the group consisting of brackets, pins, and clips. The connector may be formed from various materials, including, but not limited to stainless steel, metals, composites, ceramics, plastics, or any other suitably rigid materials.

In one embodiment, the shelf 14/32/124/150 may be sized to extend between the first column 11/40/121/140 and the second column 12/20/122. As shown in FIG. 3, the shelf 14/32/124/150 may be configured to have a substantially planar base 34/64 and two flanges (35/36)/(67/68)/(155/156), the two flanges (35/36)/(67/68)/(155/156) perpendicularly extending from the base 34/64 and disposed at opposing ends along a length of the base 34/64. FIG. 6 shows a good view of a top side 63 and an underside 65 of the shelf 14/32/124/150.

In another embodiment, the first column 11/40/121/140 and the second column 12/20/122 may define a plurality of apertures 141 as shown in FIG. 14. Each one of these plurality of apertures 141 may also be configured to removably receive a support to hold in position a shelf 150. In one embodiment, the support may be a tab 151/152, the tab being configured to be integral with the shelf 150 and outwardly horizontally extending from the base 153 of the shelf 150 and disposed at opposing ends along the width of the base 153.

In yet another embodiment, a lighting system 51/60/66 of FIG. 6 may be detachably attached to an underside 65 of the base 34/64 of the shelf 14/32/124/150 as shown in FIG. 5 and FIG. 6B, using various materials, including, but not limited to magnets, double-side tape, silicon adhesives and sealants, hook-and-loop fasteners, and the like. The lighting system 51/60/66 may comprise a light emitting diode (LED) strip 62 electrically connected to a power inlet connector 61/131. The power inlet connector 61/131 may be in electronic communication with a power outlet connector 72/132/142, the power outlet connector 72/132/142 protruding through an opening 23/43/82/83 (FIGS. 3, 4 and 8) in the first column 11/40/121/140 as depicted in FIG. 13. The power outlet connector 72/132/142 may be electrically connected to the electrical power source 70, as illustrated in FIG. 7 and FIG. 15, through a wiring 71/73/164/165/167/168. In one embodiment, the wiring 71/73/164/165/167/168 may be disposed in the interior portion 41 (similar to the second interior portion 21 of the second column 12/20/122) of the first column 11/40/121/140. The electrical power source may comprise a wiring 71/73, a power supply AC-DC transformer 74 and a 110-230V power outlet socket 75. In another embodiment, the electrical power source 70 may also be disposed in the first interior portion 41 of the first column 11/40/121/140 together with the wiring 71/73/164/165/167/168.

In still another embodiment, the illuminated shelving system may further comprise an upper panel 13/90 which is positioned above the shelf 14/32/124/150. In one embodiment, the upper panel 13/90 may comprise a frame 96, a cover panel 93 and a second lighting system (not shown but easy to envisage). The cover panel 93 may be attached to the frame 96 and the frame 96 may be securely attached to the wall using various materials, including, but not limited to screws, nails, bolts, staples, silicon adhesives and sealants, and double-sided tape, and the like. Similarly, the cover panel 93 may be attached to the frame 96 using various materials, including, but not limited to screws, nails, bolts, staples, silicon adhesives and sealants, and double-sided tape, and the like. The frame 96, which may comprise a plurality of frame members 98 joined together defining a substantially rectangular border, may be configured to have a top portion 99a and a bottom portion 99b and may be sized to extend between the first column 11/40/121/140 and the second column 12/20/122 with the top portion 99a disposed to be flush with a top 91 of the first column 11/40/121/140 and a top 92 of the second column 12/20/122 as illustrated in FIG. 9. The frame 96 may be formed from various materials, including, but not limited to stainless steel, metal, wood, composites, ceramic, plastic, or any other suitably rigid materials. In one embodiment, a second lighting system similar to the one depicted in FIG. 6 may be detachably attached to the bottom portion 99b of the frame 96 using various materials, including, but not limited to magnets, double-side tape, silicon adhesives and sealants, hook-and-loop fasteners, and the like.

In one embodiment, the second lighting system may comprise a second light emitting diode strip electrically connected to a second power inlet connector. The second power inlet connector may be in electronic communication with a second power outlet connector similar to the ones depicted in FIGS. 7 and 13, the second power outlet connector protruding through a second opening (similar to the openings 23/43/82/83 shown in FIGS. 2, 4 and 8) in the first column 11/40/121/140. The second power outlet connector may be electrically connected to the electrical power source 70 as shown in FIG. 7 and FIG. 15, through a wiring 71/73/164/165/167/168. In one embodiment, the wiring 71/73/164/165/167/168 may be disposed in the interior portion 41 (similar to the second interior portion 21 of the second column 12/20/122) of the first column 11/40/121/140. The electrical power source 70 providing a power to the second lighting system to illuminate a space above the shelf 14/32/124/150.

In still another embodiment, the illuminated shelving system may still further comprise a bottom shelf 15/95/100/125, wherein the bottom shelf 15/95/100/125 is positioned below the shelf 14/32/124/150. The bottom shelf may be configured to have a substantially planar second base 104 and two flanges 105/106 as shown in FIG. 10. In one embodiment, the two flanges 105/106 of the bottom shelf 15/95/100/125 may be of different dimensions heightwise. In another embodiment, the two flanges 105/106 of the bottom shelf may be of different dimensions heightwise when compared with the dimensions of the two flanges (35/36)/(67/68)/(155/156) of shelf 14/32/124/150. The first column 11/40/121/140, the second column 12/20/122, the shelf 14/32/124/150, the cover panel 93 and the bottom shelf 15/95/100/125 may each be formed from various materials, including, but not limited to stainless steel, metal, wood, composite, ceramic, plastic, or any other suitably rigid materials. The preferred, but not limiting, dimensions of the first column 11/40/121/140, second column 12/20/122, the upper panel 13/90, the shelf 14/32/124/150 and the bottom shelf 15/95/100/125 are shown in Table 1. Table 1 also provides the preferred, but not limiting, dimensions of the separation between the first column 11/40/121/140 and the second column 12/20/122, the separation between the shelf 14/32/124/150 and the upper panel 13/90, the separation between the shelf 14/32/124/150 and the bottom shelf 15/95/100/125, and the separation between the shelves 14/32/124/150.

In another embodiment, as illustrated in FIGS. 8 and 15, a wiring may be laid out inside the first interior portion 41 of the first column 11/40/121/140 to facilitate the electronic communication between a lighting system 60 and an electric power source 70 in order to provide a power to the lighting system 60. Each light emitting diode strip 163 may be configured to have two wires 164/165 of two different colors coming out of it and into a power inlet connector 161. The power inlet connector 161 may then be electrically connected to a power outlet connector 162, the power outlet connector 162 protruding through an opening 23/43/82/83 (FIGS. 2, 4 and 8) in the first column 11/40/121/140 as depicted in FIG. 13. The wires of the same color from each power outlet connector 162 on the first column 11/40/121/140 may then be connected together using two separate wire nuts 166, one for each wire color. The two separate wire nuts 166 may yield two wires 167 and 168 that may then exit the first column 11/40/121/140 through openings 26/46/84 and be connected to a power supply 74 of the electric power source 70. The wire nuts 166 serve to hold the joints secure and also provide insulation for the mechanical wire joints. It should also now be relatively easy to envisage another embodiment of an illuminated shelving system claimed herein whereby the wiring described above and the electrical power source 70 may both be positioned in the first interior portion 41 of the first column 11/40/121/140.

In yet another embodiment, the illuminated shelving system may further comprise a first 11/40/121/140 or second column 12/20/122 configured to have a wider width to facilitate attachment of a mirror 111 as shown in FIG. 11.

In still another embodiment, the illuminated shelving system may be configured without an upper panel 13/90 as shown in FIG. 12.

In another embodiment, a method of installing the illuminated shelving system is presented. The method may begin by securing a first column and a second column to a wall, the first column defining a plurality of apertures on a first side and the second column defining a plurality of apertures on a second side. The first side may be disposed to face the second side. In one embodiment, the attachment may be accomplished by engaging a column over a stud, the stud being attached to the wall. A plurality of screws may then be used to secure the column to the stud through mounting holes. In another embodiment, a column may be attached to the wall by using a combination of bolted steel angle and pop riveting. This may be followed by removably engaging a support to one of the first and second pluralities of apertures. In one embodiment, the support may be a connector selected from the group consisting of brackets, pins, and clips. A shelf extending between the first and second column may then be positioned on at least two supports. A lighting system may be detachably attached on an underside of the shelf.

In one embodiment, the lighting system may be electronically connected to an electrical power source by connecting through a wiring protruding through an opening in the first column. In one embodiment, the wiring may be positioned in a hollow interior portion defined by the first column. In another embodiment, both the wiring and the electrical power source may be positioned in the interior portion of the first column.

In another embodiment, the method may further include installing an upper panel above the shelf, wherein the upper panel comprises a frame, a cover panel, and a second lighting system. The frame may be configured to extend between the first column and the second column with a top portion of the frame disposed to be flush with a top of the first column and a top of the second column. The method may include securing the frame to the wall, followed by attaching the cover panel to the frame. In one embodiment, the frame may be secured to the wall using various materials, including, but not limited to screws, nails, bolts, staples, silicon adhesives and sealants, and double-sided tape, and the like. Similarly, the cover panel may be attached to the frame using various materials, including, but not limited to screws, nails, bolts, staples, silicon adhesives and sealants, and double-sided tape, and the like.

In another embodiment, the method may include detachably attaching a second lighting system to a bottom portion of the frame using various materials, including, but not limited to magnets, double-side tape, silicon adhesives and sealants, hook-and-loop fasteners, and the like. The second lighting system may be electronically connected to the electrical power source by connecting through the wiring protruding through a second opening in the first column. The second light system illuminating a space above the shelf.

In yet another embodiment, the method may still further include positioning a bottom shelf below the shelf. The bottom shelf may be configured to have a substantially planar second base and two flanges perpendicularly extending from a length of the second base.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. An illuminated shelving system comprising:
a first column and a second column, the first column defining a substantially hollow first interior portion, the second column defining a substantially hollow second interior portion, the first and second column attached to a wall;
the first column defining a first plurality of apertures on a first side, the second column defining a second plurality of apertures on a second side, the first side facing the second side, each one of the first plurality and second plurality of apertures configured to removably receive a support, the supports holding in position a shelf, the shelf extending between the first column and the second column;
the shelf having a substantially planar base and two flanges, the two flanges perpendicularly extending from the base and disposed at opposing ends along a length of the base, the base having a top side and an underside; and
a lighting system, the lighting system detachably attached to the underside of the base of the shelf, wherein the lighting system is in electronic communication with an electrical power source through a wiring, the wiring disposed in the first interior portion of the first column, the electrical power source providing a power to the lighting system to illuminate a space below the lighting system.

2. The illuminated shelving system of claim 1 wherein the support is a connector extending outwardly horizontally.

3. The illuminated shelving system of claim 2 wherein the connector is selected from the group consisting of brackets, pins, and clips.

4. The illuminated shelving system of claim 1 wherein the support is a tab, the tab being integral with the shelf and outwardly horizontally extending from the base of the shelf and disposed at opposing ends along the width of the base.

5. The illuminated shelving system of claim 1 wherein the lighting system comprises of a light emitting diode strip and a power inlet connector, the power inlet connector electrically connected to the light emitting diode strip.

6. The illuminated shelving system of claim 5 wherein the power inlet connector is in electronic communication with a power outlet connector, the power outlet connector protruding through an opening in the first column, the power outlet connector being electrically connected to the electrical power source.

7. The illuminated shelving system of claim 1 wherein the electrical power source comprises a wiring, a power supply AC-DC transformer and a 110-230V power outlet socket.

8. The illuminated shelving system of claim 1 further comprising an upper panel, wherein the upper panel is positioned above the shelf, the upper panel comprising a frame, a cover panel, and a second lighting system;
the cover panel attached to the frame;
the frame securely attached to the wall, the frame comprising a plurality of frame members joined together defining a substantially rectangular border, the frame having a top portion and a bottom portion, the frame extending between the first column and the second column, the top portion disposed to be flush with a top of the first column and a top of the second column; and
the second lighting system detachably attached to the bottom portion of the frame to illuminate a space above the shelf.

9. The illuminated shelving system of claim 8 wherein the second lighting system comprises of a second light emitting diode strip and a second power inlet connector electrically connected to the second light emitting diode strip.

10. The illuminated shelving system of claim 9 wherein the second power inlet connector is in electronic communication with a second power outlet connector, the second power outlet connector protruding through a second opening in the first column, the second power outlet connector being electrically connected to the electrical power source through the wiring disposed in the first interior portion of the first column.

11. The illuminated shelving system of claim 8 wherein the frame is formed from materials selected from the group consisting of stainless steel, metal, wood, composite, ceramic, and plastic.

12. The illuminated shelving system of claim 8 wherein the cover panel is formed from materials selected from the group consisting of stainless steel, metal, wood, composite, ceramic, and plastic.

13. The illuminated shelving system of claim 8 wherein the frame is attached to the wall using materials selected from the group consisting of screws, nails, bolts, staples, silicon adhesives and sealants, and double-sided tape.

14. The illuminated shelving system of claim 1 further comprising a bottom shelf, wherein the bottom shelf is positioned below the shelf; and
the bottom shelf having a substantially planar second base and two flanges, the two flanges perpendicularly extending from the second base and disposed at opposing ends along a length of the second base;

15. The illuminated shelving system of claim 1 wherein the first and second columns are formed from materials selected from the group consisting of stainless steel, metal, wood, composite, ceramic, and plastic.

16. The illuminated shelving system of claim 1 wherein the first column is attached to the wall by engaging the first column over a stud, the stud being attached to the wall and a plurality of screws securing the first column to the stud.

17. The illuminated shelving system of claim 1 wherein the shelf and bottom shelf are formed from materials selected from the group consisting of stainless steel, metal, wood, composite, ceramic, and plastic.

18. A method for installing an illuminated shelving system comprising the steps of:
securing a first column and a second column to a wall, a first side of the first column facing a second side of the second column, wherein the first column defines a substantially hollow first interior portion and the second column defines a substantially hollow second interior portion, wherein the first column defines a first plurality of apertures on the first side and the second column defines a second plurality of apertures on the second side;
removably engaging a support to one of the first and second plurality of apertures;
removably positioning a shelf on at least two supports, the shelf extending between the first column and the second column, wherein the shelf is configured to have a substantially planar base;
detachably attaching a lighting system on an underside of the shelf; and
electronically connecting the lighting system to an electrical power source by connecting through a wiring, wherein the wiring is positioned in the first interior portion of the first column, the electrical power source providing a power to the lighting system to illuminate a space below the lighting system.

19. The method of claim 18 further comprising the steps of:
installing an upper panel above the shelf, wherein the upper panel comprises a frame, a cover panel, and a second lighting system;
securing the frame to the wall, wherein the frame includes a plurality of frame members joined together defining a substantially rectangular border;
attaching the cover panel to the frame;
detachably attaching the second lighting system to a bottom portion of the frame; and
electronically connecting the second lighting system to the electrical power source by connecting through the wiring, the electrical power source providing a power to the second lighting system to illuminate a space above the shelf;

20. The method of claim 18 further comprising the step of:
positioning a bottom shelf below the shelf, wherein the bottom shelf is configured to have a substantially planar second base;
